(19) United States
(12) Patent Application Publication
(10) Pub. No.: US 2024/0056408 A1
(43) Pub. Date: Feb. 15, 2024

(54) COMPUTERIZED SYSTEM FOR PERIMETER INTERFACE FOR ALIAS ELECTRONIC ADDRESSES

(71) Applicant: Virtual Connect Technologies, Inc., Greenville, SC (US)

(72) Inventors: Benjamin Hathaway, Greenville, SC (US); Andrew Barringer, Duncan, SC (US); Theodore Wecker, Durango, CO (US)

(73) Assignee: Virtual Connect Technologies, Inc., Greenville, SC (US)

(21) Appl. No.: 18/366,229

(22) Filed: Aug. 7, 2023

Related U.S. Application Data
(60) Provisional application No. 63/398,142, filed on Aug. 15, 2022.
(60) Provisional application No. 63/398,137, filed on Aug. 15, 2022.
(60) Provisional application No. 63/398,132, filed on Aug. 15, 2022.
(60) Provisional application No. 63/398,127, filed on Aug. 15, 2022.

(51) Int. Cl. H04L 51/212; H04L 51/23

(52) U.S. Cl. CPC H04L 51/212; H04L 51/23

(57) ABSTRACT

A computerized system for perimeter interface for alias electronic addresses comprising: a set of computer readable instructions adapted for generated an alias email address, associated the alias email address with a true email address, analyzing incoming electronic message, retrieving the recipient information from the incoming message, associating the recipient with the alias and determining if the source of the message is from a validated source associated with the alias message. The validation source is website address, domain, individual address, group of addresses, geographic location or any combination.

### RELATED APPLICATION

This application claims priority from U.S. Provisional Patent Application 63398142 filed Aug. 15, 2022, U.S. Provisional Patent Application 63398137 filed Aug. 15, 2022, U.S. Provisional Patent Application 63398132 filed Aug. 15, 2022, and U.S. Provisional Patent Application 63398127 filed Aug. 15, 2022.

### BACKGROUND OF THE INVENTION

### 1) Field of the Invention

This system is directed to a computerized system for the determination of application, creation, management, and deletion of unique or limited exposure alias electronic messages to reduce spam and security risks associated with electronic messages.

### 2) Description of the Related Art

The use of electronic message, especially email, is prevalent in today's society. It is estimated that billions of emails are sent per day. Email is being used for several purposes including personal communications, business communications, marketing, advertising, multi-party communications, collaboration, transmitting attachments, documents, or any other information interactions, as well as many other uses. Because of its even increasing use, there is also an increase of breach attempts and security risks. There is a need for a system that can assist with the prevention of spam and unwanted messages as well as reduce the security risks associated with electronic message systems. Various methods seeking to reduce spam have been tried such as marking a non-spam electronic message as discussed in U.S. Patent Application Publication 2003/0229672; altering delivery times as discussed in U.S. Pat. No. 7,571,214 and discussing an elaborate manual system for replacement of the subscriber's native email address with a proxy address by putting the recipient's full email address in the local part of the “To” field, replacing the “@” symbol with a known replacement character, and placing the subscriber's assigned subdomain in the domain part of the “To” field, so that the sender's email is sent to a redirection server for appropriate readdressing and forwarding by using subdomains. Such systems are not tailored for specific web address locations and are cumbersome and unwieldly in implementation. Specifically, this reference requires that the email account request that the proxy address be generated. An automated system that ties alias electronic messages to one or more destinations would be desirable.

One of the reasons to reduce or eliminate direct access or knowledge to a user account electronic mail address is to lower or eliminate the risk of unauthorized access. When a hacker is aware of an email address, the hacker has a higher chance of compromising an account using phishing attempts, may attempt to obtain financial and personal information, as well as other undesirable and even illegal activities. Generally, phishing refers to an attempt to gather private, confidential, or protected information by social engineering which seeks to have potential victims disclose sensitive information under false pretenses. Phishing attacks are usually carried out via communication channels such as email or instant messaging by fraudulent or misleading actors posing as legitimate and trustworthy entities so that the victim “trusts” the bad actor and discloses such information. It is desirable to identify risks that can lead to successful phishing attempts and provide preventive measures so that these attempts can be reduced if not eliminated. It has been reported that 3.4 billion phishing emails are sent each day worldwide and 45.37% of all email sent in 2021 were phishing emails. Phishing attempts are one of the more severe and widespread type of cybercrimes reported. The same report stated that approximately 90% of all data breaches are the results of successful phishing attempts.

When a spammer has access or knowledge of an account holder's email address, the spammer can use such spam to send unsolicited advertisements and even attempt phishing, penetration, and other attacks as well. Generally, spamming is an industry and exists to lure account holders into purchasing goods and services. Spam can be analogized to digital junk mail with substantially lower costs on a per recipient basis than physical mailings. The spammer is incentivized to send as many spam messages as possible relying on the fact that some recipients will purchase a good and service and, with over 320 billion spam emails sent every day, only a small percentage need to purchase to justify the spammers effort. Spam can be even more profitable for the spammer as some spam if a forgery of legitimate goods and services but redirects the payment to the spammer.

There have been attempts to automatically filter or identify undesirable electronic messages such as shown in U.S. Pat. No. 9,501,746 which discloses a system related to detecting bad actors that impersonate other people's identity in order to increase the likelihood of recipients opening these bad actors' messages and attachments. This patent states that this undesirable activity is generally referred to as “phishing” and specifically “spear phishing” when the recipient is targeted by the fake sender who is referred to as a “phisher.” This patent also states that these phishers send these “fake emails” seeking to increase their likelihood of successfully gaining unauthorized access to confidential data, trade secrets, state secrets, military information, and other information. The motivation of these phishers is typically for financial gain through fraud, identity theft and/or data theft, as well as those which wish to disrupt normal operations. Phishing attempts have been associated with private entities as well as being state sponsored and even from foreign governments themselves.

One attempt to detect and/or handle targeted potential attacks to an electronic message system are shown in U.S. Pat. Nos. 9,686,308 and 10,181,957 which disclose a system for detecting and/or handling target attacks in an enterprise's email channel. This patent discloses receiving aspects of an incoming electronic message addressed to a first email account holder, selecting a recipient interaction profile and/or a sender profile from a plurality of predetermined profiles stored in a memory, determining a message trust rating associated with the incoming email message based upon the incoming email message and the selected recipient interaction profile and/or the sender profile; and generating an alert identifying the incoming email message as including a security risk based upon the determined message trust rating. However, these techniques are limited to the message being received by the electronic message system and limited to the relationship between the sender and the recipient. It would be advantageous to have a system that can reduce the risks of such attacks and other security risks so that the email owner's security protection can be increased.

Another attempt to detect, prevent, and provide notification of phishing attempts is shown in U.S. Pat. No. 10,404,745 which discloses the use of natural language techniques and information present in an email (namely the header, links, and text in the body) to detect phishing. This system is limited to an analysis of the email itself and occurs once the phishing attempt or attack has been initiated. It would be advantageous to reduce the ability of a phishing attempt to occur in the first place, rather than an “after-the-fact” solution, as in the prior art.

One attempt to prevent online fraud is shown in U.S. Pat. No. 10,628,797 that states that the system can receive and categorize incoming email messages and attempts to determine whether the incoming email is being used to attempt an unauthorized access to data, accounts, information, and the like. Another attempt is discussed in U.S. Patent Application 20080313704 that discusses a system for electronic message authentication rejecting messages from compromised machines, testing messages to validate recipients, sending a challenge message, and holding the received message pending receipt of a reply.

Therefore, it is an object of the system to provide for a system that can determine if the recipient has attempted to send an electronic message to a detected email address, potentially indicating that unauthorized access has occurred.

It is another object of the system to provide response to an actual or potential unauthorized access of an electronic system.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A is a schematic of aspects of the system.

FIG. 1B is a schematic of aspects of the system.

FIG. 2 is a schematic of aspects of the system.

FIG. 3A is a schematic of aspects of the system.

FIG. 3B is a schematic of aspects of the system.

FIG. 3C is a schematic of aspects of the system.

### DETAILED DESCRIPTION OF THE INVENTION

With reference to the drawings, the invention will now be described in more detail.

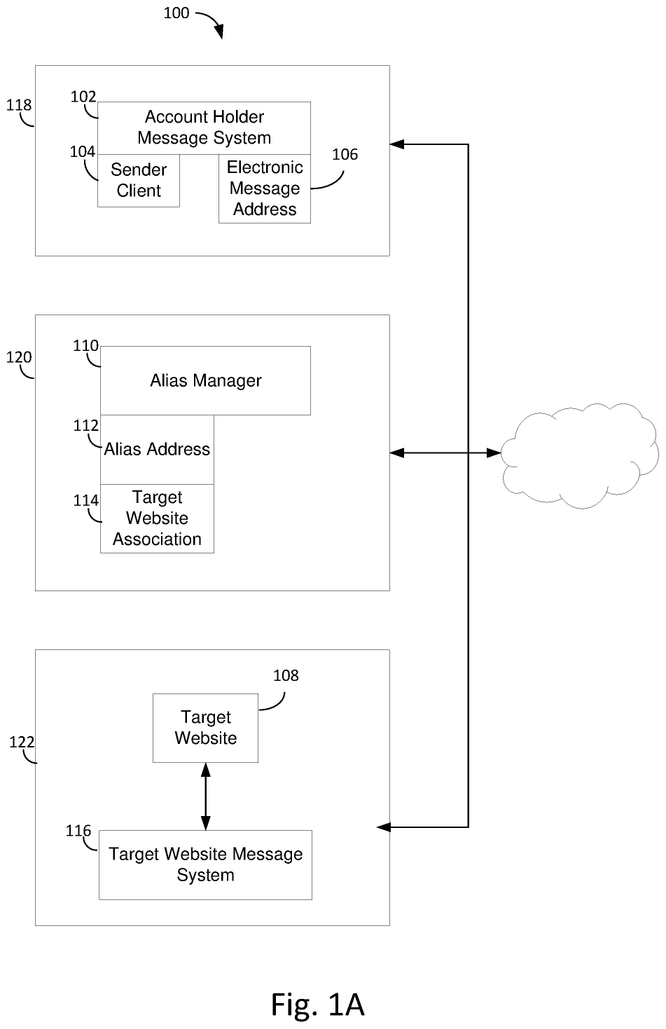

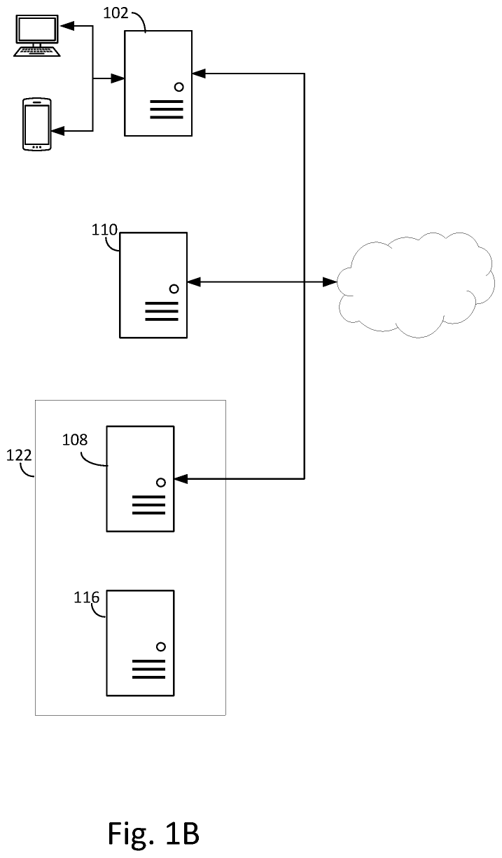

Referring to FIGS. 1A through 1C, an account holder system is shown generally as 100 and can include an account holder message system 102 and account holder client 104. The account holder can include an electronic message address 106 that is associated with the account holder. In one embodiment, the electronic message address is a unique address that is associated with the account holder, such as accountholder@domain.com. The account holder may wish to access, open an account or otherwise interact or transact with the target website 108. In some cases, the targe website requests an electronic message address to be used to access, open an account or otherwise interact or transact with the target website. The account holder can access an alias manager 110 and request that an alias electronic message address 112 be generated and provided to the account holder. The alias manager can provide the alias address 112 and associate the alias address with the target website 114 and the account holder electronic message address, such as associating the alias address with the URL or domain for the target website. The alias address can be unique to the account holder and the target website. The alias address can be associated with the electronic message address. The alias address can be used by the account holder to access, open an account or otherwise interact or transact with the target website. Therefore. The electronic message address of the account holder is not revealed to the target website and therefore is at substantially less risk for being breached or otherwise obtain without authorization from the account holder.

The alias manager can be included in the account holder domain or can be in communications with the account holder message system, disposed outside the account holder's domain. The alias manager can be integrated in the account holder message system, access the account holder message system with an API or can be in communications with the account holder message system. Communications can be wired, wireless, local network, wide area network or any combination thereof. Communications can be between the account holder domain 118, the alias domain 120, the target domain 122 and any combination thereof.

An account holder wishing to access a target web address or domain associated with the target website 108 regarding some information, good or service, and may be required to provide an email address to the target for purposes of conducting e-commerce, sending information, receiving information or other activities, including commercial activities. When an email is required from the website, the account holder can provide the alias address to the website without revealing the account holder electronic message address.

The target website may have a target website message system 116 that can be used to send information such as confirmation, verification, validation, and other information messages to the account holder 104 using an electronic message generated from the target website message system 116 to the alias address 112. When the message is sent, the alias message manager 110 can receive the message and forward the message to the electronic message address 106. By using an alias address 112, the account holder can send a message to target message system 116 without revealing the electronic message address and autonomously having messages sent to target message system using alias addresses.

The target website message system 116 that receives the alias address can use the associated MX record to send a message intended for the account holder. The website message system can send a message to the alias address 112 which results in the message being delivered to alias manager 110. The alias manager can analyze the message and determine if the intended recipient (the account holder) of the website message system is associated with the website. If so, the alias manager can forward the message to the true electronic message address 106 of the account holder so that the account holder receives the message from the website. The message to the intended recipient (account holder) can be transmitted to the account holder domain, recipient message system 102 and retrieved by the recipient using a client 104 or other account access such as webmail, SaaS, PaaS, laaS, or another vehicle.

This system also improves the existing technology by providing a method for detecting messages such as spam, phishing, and other undesirable messages. If the alias address 112 received by the alias manager is not associated with the target website 108 and/or the target website URL 114, the alias manager 110 can take one of several actions that can include quarantine, deletion, notification to a user of the account holder messages system, blacklisting, and even a reply message such as address not found other such responses and messages. The ability to determine that an alias address is being used that was not specifically created and associated with a target website can be a result in the detection of an undesired message.

For example, if the target website sells its email list, the website the account holder may receive a message addressed to the alias address that did not originate from the target website message system 116. In this case, it indicates that the alias email has been sold, the target website message system has been compromised, or other activity has occurred allowing undesirable access to the alias address 112. The alias manager 110 can filter out or otherwise prevent such messages from reaching the account holder.

This process can be repeated where the first alias electronic message address is associated with a first website and a second electronic message is associated with a second website. If the first website decides to sell its email list, when the alias manager receives a message having the alias address associated with a sender associated with a second website, the system can determine that the first website provide emails to the second website, or website operator, so that the alias manger can determine that the first website, or operator, has distributed email addresses.

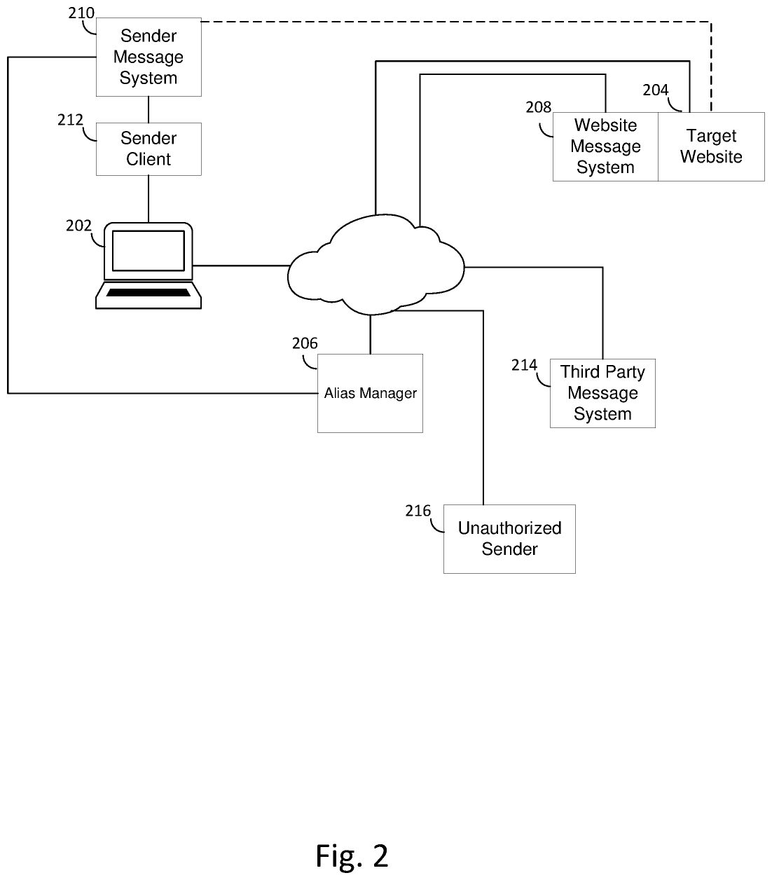

Referring to FIG. 2, the account holder using an account computer device 202 wishes to access or otherwise transaction with a first target website 204. The account computer device can be a desktop computer, tablet, portable device, or other computer device that can access the sender message system. When the account holder wishes to transact with the target a request can be made by the account holder either to the alias manager or through the sender message system requesting an alias address. The alias manager 206 can provide an alias electronic message address which can be associated with the target website and the account holder and can be a one-to-one relationship between the account holder electronic address and the alias address and the alias address and the target website. This relationship can be shown as follows:

E⇄A⇄T (1)

where E is the account holder electronic message address, A is the alias address and alias address and Tis the target website 204, target message system 208. When the target website sends an electronic message to the alias address, directly or through a third party message system 214, alias manager forwards the message to the account holder electronic message address allowing the account holder to view the message using the account holder message system 210. In the event that the target website owner or operator or a third party used by the target website owner or operator sells its email list, is compromised, was a spammer or hacker originally, or otherwise seeks to send spam or compromise the account holder account or message system, an electronic message (e.g., spam, compromise attempt, or attack) could be sent from an unauthorized (e.g., spammer) message system 216 that is addressed to the alias address 208. In this case the spam, undesired or mal-intended message can be received by the alias manager and the alias manager can determine that the message send to the alias address does not originate from the target domain, the message can be determined to be spam, undesired or mal-intended. The alias manager 206 can determine that the target website 204 or the website message system 208 has been compromised and/or is subject to unauthorized access. The alias manager 206 can then communicate with a third-party message system 214 and communicate that the website or website message system most likely has been compromised or has been accessed, without authorization, by a bad or undesirable actor. The alias manager can also inform the account holder or other individual associated with the sender message system of actual or potential compromise.

When multiple aliases are used for multiple targets, the following can illustrate the relationships:

$$E ↔ \frac{{A}_{1} ↔ {T}_{1}}{{A}_{2} ↔ {T}_{2}} \qquad ( 2 )$$

Further when the target can have affiliates, the same allies address can be used for each affiliate which can be represented as follows:

$$E ↔ \frac{{A}_{1} ↔ \frac{{T}_{1 - 1}}{{T}_{1 - 2}}}{{A}_{2} ↔ \frac{{T}_{2 - 1}}{{T}_{2 - 2}}} \qquad ( 1 )$$

Therefore, in one embodiment a message generated from target domain T₁₋₁ or T₁₋₂ sent to A₁ would not necessarily indicate an improperly released of exposed alias address.

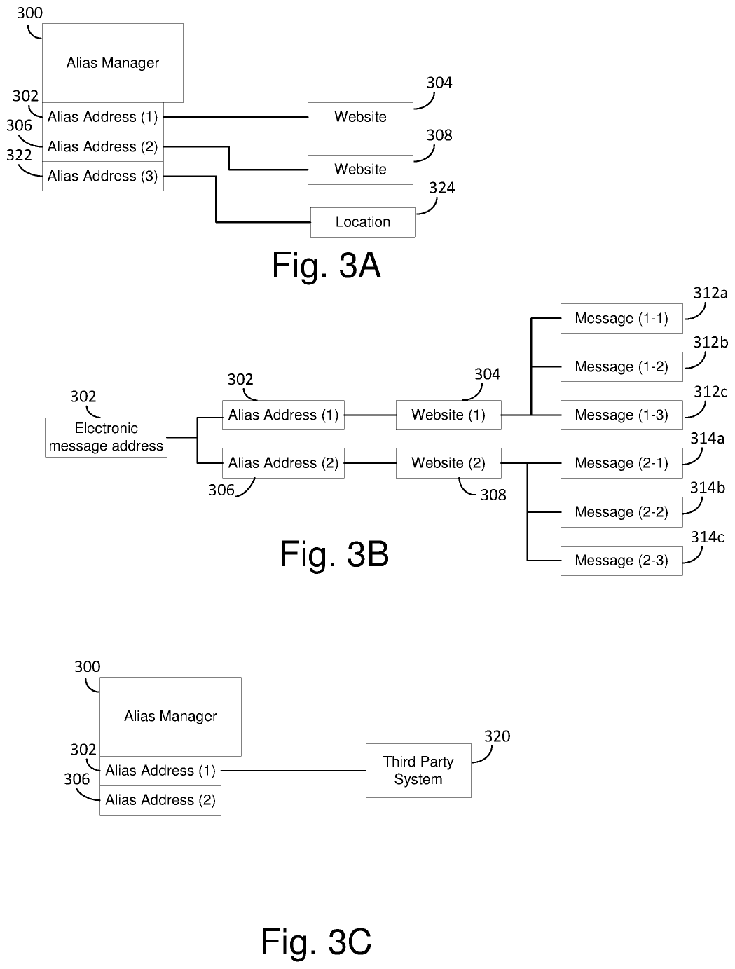

Referring to FIGS. 3A and 3B, the alias manager 300 can create a first alias electronic address 302 that is associated with a first website 304. Therefore, when the alias manager 300 receives a message from a message system that is not associated with the alias address, the alias manager can take appropriate action. The alias manager can also generate a second alias electronic message address 306 that is associated with the account holder electronic address and a second target website 308. In one embodiment, there are unique alias addresses associated with the account holder electronic address 310 in a one-to-many relationship while each alias address is associated with a target website in a one-to-one relationship. Message 312a through 312c can be transmitted from the target website or system and can be sent to the alias manager and on to the accountholder. The messages 312a through 312c, addressed to the first alias address 302 would be in the normal course of communications. Similarly, message 314a through 314c addressed to the alias address 306 would be in the normal course of communications.

However, were a target website, such as target 308 be compromised or otherwise disclose address to a third party, the alias manager 300 may receive a message from third party system 320 addressed to an alias address such as 302. In this case, the alias manager can determine that the message originates from the third-party system 320 which is not associated with the alias address thereby indicating that a potential compromise or unauthorized distribution of the alias address has occurred.

Therefore, if the alias manager receives a message that is addressed to the alias 320, but not from the system 304, the alias manager can act. This functionality improves the ability for detecting spam, what is likely spam, mal-intended message, and other undesirable message and prevent it from reaching the account holder electronic address by limiting the ability of message from being received into the account holder message system.

The alias manager can also limit the time that the alias electronic address will forward a received message to the account holder. For example, when communicating with a political candidate, the accountholder may only wish to receive messages from that specific political candidate and only for the time during which the campaign is running (e.g., prior to election day). Therefore, the alias manager can prevent any received message from being delivered to the account holder after a certain period. In this embodiment, the alias manager can expire the alias address so that the alias address becomes undeliverable after the period.

The alias manager can also create an alias address 322 and associate that address with a physical or geographic location 324. If a message received is not associated with a target domain that is associated with that physical or geographic location, the alias manager can take the appropriate action. For example, the alias manager can associate the alias address with the IP address 192.0.66.168 having an physical location in the Washington DC area. When the incoming message to the alias address originates in a geographic area that is not in the Washington, DC area, the alias manger can determine that he originator of the message may be sending a undesirable message of that the owner of the domain location at the IP address has been compromised or distributed the email addresses sent to it. The alias manager can also receive input from the account holder that can allow the alias address to be associated with one or more locations. For example, the target domain can have facilities in two locations so that a message from the target location from two domain locations can be determined to be appropriate.

The alias manager can also associate the alias address with affiliated domains. In some embodiment, the target website can have affiliated domains so that the alias can be associated with domainone.com and domaintwo.com. Since the domains can be affiliated, receiving messages to the alias address from either domain can be deemed appropriate. For example, auniversity.edu and universityfoundation.com can be affiliated so that receiving a message from either can be deemed appropriate and may not indicate a unauthorized distribution or access to the alias address.

In one embodiment, the alias manager can intercept an outbound message and substitute the recipient “From” information, included in the header, with the alias message address. For example, if the website that is accessed by the account holder uses the domain companyone.com and the intended address from the account holder is to inventions@companyone.com, the alias manager can substitute the alias in the outgoing message. The outgoing message can be analyzed by the alias manager and discover that the following is in the message:

| | |
|---|---|
| To: Name <inventions@companyone.com> | (1) |

The alias manager can substitute the following for this field:

| | |
|---|---|
| To: Alias <alias-address@gateway-alias-01.com> | (2) |

When using locations, the alias manager can determine an IP address of the received message and therefore determine a physical location. If the message being received originates from a physical location that is not associated with the alias, the alias manager can act.

In one embodiment, the alias manager can respond to the message that is not verified or is unauthorized with any number of the following:

| | |
|---|---|
| Address not found | (3) |
| Mailbox not found | (4) |
| Invalid mailbox | (5) |
| User unknown | (6) |
| Mailbox unavailable | (7) |
| Undeliverable | (8) |
| Timed out | (9) |

When the alias manager determines that the alias address is being used to send a generated email, it can indicate that the sender account has been subject to unauthorized access. In this case, the alias manager can take any number of actions including the following:

Generate a warning that can be transmitted to the electronic message system, administrator, recipient, third party (e.g., blacklist), reputation administrator, or other third party.

Lock the account of the sender.

Quarantine outbound electronic messages.

Delete one or more outbound messages.

Modify the header of the message indicating that the email is or may be from a compromised account.

Require a password reset for the sender's account.

Require multifactor authentication for the sender's account.

Initial a scan of the electronic message system of the user's account.

Require a change in security questions.

Verify security or privacy settings.

And any combination of the above.

During the process of analyzing the email that the sender message system is attempting to send, the alias manager can analyze components of header seeking information about the recipient.

| | |
|---|---|
| Received: from CY4PR2201MB1384.namprd22.prod.outlook.com | (10) |
| (2603:10b6:910:6a::22) by SN4PR22MB2902.namprd22.prod.outlook.com | |
| with HTTPS; Tue, 28 Jun 2022 14:55:33 +0000 | |
| Received: from MW2NAM04FT012.eop- | (11) |
| NAM04.prod.protection.outlook.com (2603:10b6:303:2a:cafe::2) by | |
| MW3PR06CA0018.outlook.office365.com (2603:10b6:303:2a::23) with | |
| Microsoft SMTP Server (version=TLS1_2, | |
| cipher=TLS_ECDHE_RSA_WITH_AES_256_GCM_SHA384) id | |
| 15.20.5373.16 via Frontend Transport; Tue, 28 Jun 2022 14:55:31 +0000> | |
| Received: from otransport-12.outbound.emailsrv.net (52.1.62.31) by | (12) |
| MW2NAM04FT012.mail.protection.outlook.com (10.13.31.127) with | |
| Microsoft SMTP Server (version=TLS1_2, | |
| cipher=TLS_ECDHE_RSA_WITH_AES_256_GCM_SHA384) id | |
| 15.20.5373.15 via Frontend Transport; Tue, 28 Jun 2022 14:55:31 +0000 | |
| Received: from NAM10-MW2-obe.outbound.protection.outlook.com (mail- | (13) |
| mw2nam10lp2106.outbound.protection.outlook.com [104.47.55.106]) by | |
| ogate-3.outbound.emailservice.io (Postfix) with ESMTPS id D2D80A966C | |
| for <doug@kimandlahey.com>; Tue, 28 Jun 2022 14:55:29 +0000 (UTC) | |
| DKIM-Signature: v=1; a=rsa-sha256; c=relaxed/relaxed; | (14) |
| d=Mailprotector.onmicrosoft.com; s=selector2-Mailprotector-onmicrosoft- | |
| com; | |
| h=From:Date:Subject:Message-ID:Content-Type:MIME-Version:X-MS- | |
| Exchange-SenderADCheck; | |
| bh=CN+f5XFwlaGaTKhNrulNut5x7oE5mnx3t4xVI+4qvkQ=; | |
| Received: from DM4PR19MB5761.namprd19.prod.outlook.com | (15) |
| (2603:10b6:8:60::17) by BN0PR19MB5278.namprd19.prod.outlook.com | |
| (2603:10b6:408:151::17) with Microsoft SMTP Server (version=TLS1_2, | |
| cipher=TLS_ECDHE_RSA_WITH_AES_256_GCM_SHA384) id | |
| 15.20.5373.18; Tue, 28 Jun 2022 14:55:26 +0000 | |
| Received: from DM4PR19MB5761.namprd19.prod.outlook.com | (16) |
| ([fe80::d447:8c8:3b5c:1119]) by | |
| DM4PR19MB5761.namprd19.prod.outlook.com | |
| ([fe80::d447:8c8:3b5c:1119 % 9]) with mapi id 15.20.5373.018; Tue, 28 Jun 2022 | |
| 14:55:26 +0000 | |
| From: SenderName <sender.name@compaynone.com> | (17) |
| To: RecipientName <recpient@companytwo.com> | |
| Subject: Intellectual Property | |
| Thread-Topic: Intellectual Property | |
| Thread-Index: | |
| AQHYiiN1/x19gZsj6EuDAE8S5xw5nq1k0sUAgAAKU4CAAAbpgIAABesA | |
| Date: Tue, 28 Jun 2022 14:55:26 +0000 | |
| Message-ID: <4397EC37-3901-4122-AE57- | |
| 28305CF8B2F7@compayone.com> | |
| In-Reply-To: | (18) |
| <SN4PR22MB2902782099AD395EA9F4382ED1B89@SN4PR22MB2902.namprd22.prod.outlook.com> | |
| Accept-Language: en-US | |
| Content-Language: en-US | |
| X-MS-Has-Attach: | |
| X-MS-TNEF-Correlator: | |
| Authentication-Results-Original: | |
| dkim=none (message not signed) | |
| header.d=none; | |
| dmarc=none action=none | |
| header.from=companyone.com; | |
| spf=none; | |
| X-Microsoft-Antispam-Message-Info-Original: | (19) |
| zzKZNSEnd7Z8oihwEWwkiQF6Pvi6TIIIobQXfo7PWxoDRY9M29iCAY3Yr | |
| P9cnFYiGy0Uf0DB7HPRnb0pAMo8kEIVS7yw1YNCJY9KfDuMkpcD5u8T | |
| z/gvvN+fXS/liXZZFGMQQ9w/GCm4PZBsEQJ7vF2h7wWaMVWdK9BzkW | |
| 5uJMxBqFyRsKeHMDOJmq+HdCAfUcQH0qJegXbkoXBFiVqICIL787luOh | |
| 6LGcx3N28FaW/WycZIpTKTq54CQjUU99JaMPpdVWfxh7Qz4Zv35CQ3P | |
| qwgODUGasTYdM9BYxULY1aPyYBtvTKyrkJqOrX/6EIEAndqS5MvDKDP | |
| 5xBT26zl3vy+E+s87XLW5/VZNUilgclqLKQAOYuDYPugHVZG4ENwy97it | |
| 1eEb4Jblz4eu0HXtCRtI9uv40mr3/m/YV8iexZtnP21bNUG85n82JVrbBwz7 | |
| W6kS/g3FVzOSIrFncs1ARF8trPLOiLxIBUQ4NNzSWohQhwRg8cm2fPOrz | |
| iSv581/TtA3NWdJ+trW8BDJjfuHDzWY/bL4vmZhU9h7uNw7fAsmW+sdtniE | |
| yaKeenYPrOdwBShlbfqQ42vHNag+EH/xLjUCBDcZjUICeLelitPBHffoDtca | |
| GtIVBE2zqkXWvYBJ5tXUrpZ3vG7PdE8ejtv41yNku1Oc2NrvZIFt2J2/w5Ub | |
| t80msrQ4VB1X1IPrYFAGjZW8incjFwCXEMjg4oC5+UioHpWhk+dq9/v0B | |
| MgSZhdmknhcVAGW4fxLkd2/ufjMYsc07/P+B9qrm T6fuNIv2mkL4KROvs0 | |
| IQwAoq38dyvbmreofMFbrwVizdWArpDGaNnrxqIpIIhcLSzpOxA4Qiin/AT/r | |
| wjFGI+y1t9XIMe68iAAqORjrw9zbMG03+PBWJ9fFwZdNpZeWeeB+73uH | |
| dRA8hm1uhiezKsM4PVOUsU= | |

The alias manager can also be connected to multiple message systems and multiple domains. The alias manager can determine that a message system may have been comprised and/or subject to unauthorized access when multiple account holders are receiving electronic messages from the alias address. This can indicate that the website receiving the alias address has been compromised or otherwise allowed the alias address to be exposed to unauthorized access. This can be communicated to other message systems. Therefore, when the alias manager determine that a system has been compromised, it can communicate to message system informing them of the risks from the target website.

The system described herein is directed to a series of acts that can protect a computer or computer system from electronic communication that may contain malicious code of other undesirable content. The computerized system is one that is at least directed to a process. The system can identify and potentially isolate electronic messages in an electronic message system according to the edge value and/or the confidence values. The edge value and confidence values associated with a sender or electronic message can be stored in a database that can be accessible by a second analytical computer system that does not have to be in direct communications with the first analytical computer system. The processes and procedures that are described herein can be actuated by a computer processor that executes computer readable instructions to provide the functionality herein.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A computerized system for creating and managing alias electronic addresses comprising:
an account holder message system having an electronic message address associated with an account holder;
an alias manager in communication with the account holder message system and adapted to:
receive a request for an alias address, create an alias address, receive a target domain, associate the target domain with the alias address, transmit the alias address to the target domain;
receive an inbound message from a target domain message system addressed to the alias address, transmit the inbound message to the electronic message address according to a determination that the alias address is associated with the target domain; and,
take remedial action against the inbound message according to a determination that the alias address is not associated with the target domain.

2. The system of claim 1 wherein the alias manager is adapted to modify an outbound message from the account holder to remove the electronic message address from a message sent by the account holder and insert the alias address in its place.

3. The system of claim 2 wherein the alias address inserted is dependent upon the domain of a recipient.

4. The system of claim 3 wherein the domain of the recipient is the target domain.

5. The system of claim 1 wherein remedial action is taken from the group consisting of quarantining, deleting, blacklisting, sending a reply message, generating a notification and any combination thereof.

6. The system of claim 5 wherein the notification is a notification representing that the target domain potentially has been accessed without authorization and the alias manager is adapted to transmit the notification to the target domain.

7. The system of claim 5 wherein the alias manager is adapted to transmit the notification to a user of the account holder messages system.

8. The system of claim 1 wherein the alias address is unique to the account holder and the target domain.

9. The system of claim 1 wherein the alias manager is adapted to expire the alias address and send a reply that the alias address is undeliverable to a sender upon such expiration.

10. The system of claim 1 wherein the alias manager is adapted to determine a geographic location of the target domain and take remedial action when an electronic message addressed to the alias address originates from a geographic area differing from the geographic area of the target domain.

11. The system of claim 1 wherein the account holder message system is a first account holder message system, and the alias manager is adapted to notify a second account holder message system that the target domain message system potentially is being accessed without authorization.

12. A computerized system for creating and managing alias electronic addresses comprising:
an account holder message system having an electronic message address associated with an account holder;
an alias manager adapted to:
receive a request for an alias address associated with the account holder,
create an alias address according to the request wherein the alias address is adapted to be used to open or access an account associated with a target domain,
associate the target domain with the alias address,
receive an inbound message from a target domain message system addressed to the alias address, and,
transmit the inbound message to the electronic message address according to the association of the alias address with the electronic message address.

13. The system of claim 12 wherein the alias manager is adapted to transmit the inbound message to the electronic message address according to a determination that the alias address is associated with the target domain.

14. The system of claim 12 wherein the alias manager is adapted to take remedial action against the inbound message according to a determination that the alias address is not associated with the target domain.

15. The system of claim 14 wherein the remedial action is taken from the group consisting of quarantining, deleting, blacklisting, sending a reply message, generating a notification and any combination thereof.

16. The system of claim 14 wherein the alias address includes an MX record pointing to the alias manager.

17. The system of claim 14 wherein the alias manager is adapted to transmit a reply to the target domain address in response to the inbound message.

18. The system of claim 14 wherein the alias manager is adapted to intercept an outgoing message from the account holder message system that is addressed to the target domain and to substitute the alias address for the electronic message address.

19. A computerized system for creating and managing alias electronic addresses comprising:
an account holder message system having an electronic message address associated with an account holder;
an alias manager adapted to:
intercept an outgoing message from the account holder message system addressed to a target domain,
retrieve an alias address associated with the target domain,
substitute the alias address for the electronic message address in the outgoing message, and,
transmit the outgoing message to the target domain.

20. The system of claim 19 wherein the alias manager is adapted to receive an inbound message from the target domain message system addressed to the alias address and transmit the inbound message to the electronic message address according to the association of the alias address with the electronic message address.
